(19) United States
(12) Patent Application Publication
(10) Pub. No.: US 2021/0292564 A1
(43) Pub. Date: Sep. 23, 2021

(54) TREATED POROUS MATERIAL

(71) Applicant: DOW GLOBAL TECHNOLOGIES LLC, Midland, MI (US)

(72) Inventors: Xue CHEN, Manvel, TX (US); Stephen W. KING, League City, TX (US); Manesh Nadupparambil SEKHARAN, Pearland, TX (US)

(21) Appl. No.: 16/334,601

(22) PCT Filed: Sep. 28, 2017
(86) PCT No.: PCT/US2017/054009

§ 371 Date: Mar. 19, 2019

Related U.S. Application Data
(60) Provisional application No. 62/401,976, filed on Sep. 30, 2016.

(51) Int. Cl. C08L 97/02; B27K 3/15; B27K 3/00; B27K 3/50; C08L 23/20

(52) U.S. Cl. CPC C08L 97/02; B27K 3/153; B27K 3/005; B27K 3/50; C08L 2201/54; B27K 2240/70; B27K 2240/30; B27K 2240/20; B27K 2240/90; C08L 23/20

(57) ABSTRACT

A method for preparing a treated cellulosic material comprising: providing a cellulosic material; a treatment protocol comprising impregnating the cellulosic material with an aqueous dispersion comprising a polybutene and a stabilizing agent.

### BACKGROUND

Porous materials, such as cellulosic materials, need to be protected from insect attack, rot and water impregnation to help preserve the physical properties of the cellulosic material. One example of such a cellulosic material is wood. A variety of treatment agents and preservation methods are known to preserve cellulosic materials.

Modern preservation methods typically involve pressure treating the cellulosic material with a treating agent. Pressure treatment typically allows the treating agent to penetrate throughout the porous structure of the cellulosic material. The treating agent is typically a chemical compound selected to impart the desired physical properties to the cellulosic material. For example, treating agents that increase hardness, add water resistance and improve the dimensional stability of the cellulosic material are of interest. Wood is capable of absorbing as much as 100% of its weight in water which causes the wood to swell, which after loss of water through evaporation causes the wood to shrink.

This process of water absorption/evaporation is non-uniform and creates internal stresses in the wood leading to splitting, warping, bowing, crooking, twisting, cupping, etc. Also, water can serve as a pathway for organisms that degrade the cellulosic material, such as insects or fungus. Treating agents that repel insects, or minimize the formation of fungi, or improve the overall durability of the cellulosic material are of interest. Further, treating agents can improve wind resistance, ultraviolet radiation resistance, stability at high and low temperatures, pest resistance, fire resistance and other issues which might affect the physical properties of the cellulosic material.

An improved treating agent for cellulosic materials is desired.

### SUMMARY

A method for preparing a treated cellulosic material comprising: providing a cellulosic material; a treatment protocol comprising impregnating the cellulosic material with an aqueous dispersion comprising a polybutene and a stabilizing agent.

### DETAILED DESCRIPTION

As used herein, the term “porous material” refers to a material which is permeable such that fluids are movable therethrough by way of pores or other passages. An example of a porous material is a cellulosic material. Other examples of porous materials include stone, concrete, ceramics, and derivatives thereof. As used herein, the term “cellulosic material” refers to a material that includes cellulose as a structural component. Examples of cellulosic materials include wood, paper, textiles, rope, particleboard and other biologic and synthetic materials. As used herein, wood includes solid wood and all wood composite materials (e.g., chipboard, engineered wood products, etc.). Cellulosic materials generally have a porous structure that defines a plurality of pores.

As used herein, unless otherwise indicated, the phrase “molecular weight” refers to the weight average molecular weight. In some instance, the molecular weight is measured by GPC (Gel permeation chromatography).

A “treated cellulosic material” is a cellulosic material that has been treated with a treating agent to modify the properties of the cellulosic material. The properties modified by the treating agent include, but are not limited to, increased hydrophobicity, dimensional stability, fungi resistance, insect resistance, hardness, surface appearance, UV stability, fire resistance, and coatability. Increasing the hydrophobicity of a cellulosic material can provide other ancillary benefits, such as dimensional stability, by reducing the rate of water adsorption and evaporation, thus reducing the internal stresses of expanding and contracting.

A “treating agent” is a substance that, when combined with the cellulosic material, modifies the properties of the cellulosic material. In one instance, the treating agent comprises an aqueous dispersion comprising a polybutene and a stabilizing agent. The treating agent is applied to the cellulosic material. One method of applying the treating agent to the cellulosic material is through impregnation using pressure treatment. In one instance, the polymer is applied to the cellulosic material as part of a dispersion. Other methods of applying the treating agent are known, such as brushing, spraying, dipping, soaking and extrusion. Once applied, the treating agent will permeate at least a portion of the pores of the cellulosic material.

In one instance, the polybutene comprises an olefinic polymer formed from butene monomers, including 1-butene, 2-butene and isobutylene. In one instance, the polybutene is selected with a molecular weight of less than 3000. In one instance, the polybutene is selected with a molecular weight of less than 2000. In one instance, the polybutene is selected with a molecular weight of less than 1500. In one instance, the polybutene is selected with a molecular weight of less than 1000. In one instance, the polybutene is selected with a molecular weight of greater than 300.

In one instance, the polybutene is a constituent part of an aqueous dispersion. In one instance, the dispersion is a medium that comprises the polymer, water and a stabilizing agent. The aqueous dispersion is prepared such that the suspended particle size in the dispersion is suitable for penetrating the pores of the cellulosic material for distribution through the cellulosic material. In one instance, the average particle size of the solids in the aqueous dispersion is greater than 0.01 microns. In one instance, the average particle size of the solids in the aqueous dispersion is less than 50 microns. In one instance, the average particle size of the solids in the aqueous dispersion is less than 4.0 microns. In one instance, the average particle size of the solids in the aqueous dispersion is less than 3.0 microns. In one instance, the average particle size of the solids in the aqueous dispersion is less than 2.0 microns. The aqueous dispersion is prepared such that the viscosity of the aqueous dispersion is suitable for penetrating the pores of the cellulosic material for distribution through the cellulosic material. In one instance the viscosity of the aqueous dispersion is less than 100,000 cP at ambient temperature. In one instance the viscosity of the aqueous dispersion is less than 1,000 cP at ambient temperature. In one instance, the viscosity of the aqueous dispersion is less than 500 cP at ambient temperature. In one instance, the dispersion also comprises one or more additives. In one instance, any solids present in the aqueous dispersion are held in a stable suspension and are transportable by the dispersion into the pores of the cellulosic material. In one instance, the polybutene content of the dispersion is 1 to 75 weight percent. In one instance, the solid content of the dispersion is 5 to 75 weight percent. In one instance, the solid content of the dispersion is 5 to 55 weight percent. In one instance, the solid content of the dispersion is 10 to 50 weight percent. In one instance, the solid content of the dispersion is 15 to 45 weight percent. In one instance, the solid content of the dispersion is 20 to 40 weight percent.

The stabilizing agent is a substance that stabilizes the aqueous dispersion. In one instance, the stabilizing agent is a surfactant. For example, suitable surfactants may be nonionic or anionic. Examples of nonionic surfactants include: alkoxylated alcohols, alkoxylated alkyl phenols, fatty acid esters, amine and amide derivatives, alkylpolyglucosides, ethylene oxide/propylene oxide copolymers, polyols and alkoxylated polyols. For example, a nonionic surfactant is TERGITOL™ L-62, commercially available from The Dow Chemical Company. Examples of anionic surfactants include: alkyl sulfates, alkyether sulfates, sulfated alkanolamides, alpha olefin sulfonates, lignosulfonates, sulfosuccinates, fatty acid salts, and phosphate esters. For example, an anionic surfactant is DOWFAX™ C10L, commercially available from the Dow Chemical Company. In one instance, the stabilizing agent is suitable for being processed at temperatures up to 200° C. In one instance the concentration of the surfactant is 0.1 to 20% in the dispersion. In one instance the concentration of the surfactant is 1 to 10% in the dispersion. The stabilizing agent is a nonionic surfactant, an anionic surfactant, or a mixture of both.

The treating agent is combined with the cellulosic material. In one instance, the treating agent is introduced to the cellulosic material by pressure treatment, as described herein. In another instance, the treating agent is introduced to the cellulosic material by other techniques known in the art, for example, brushing, dipping, soaking, spraying, and extrusion. The treating agent becomes impregnated in at least a portion of the pores of the cellulosic material, and thereby increases the weight of the cellulosic material. In one instance, the treating agent—the combination of the polybutene and the stabilizing agent—increases the weight of the cellulosic material by 5 to greater than 100 percent (as calculated after drying the cellulosic material).

In one instance, the treating agent comprises one or more additives. The additive may be included as part of the dispersion containing the polymer, or may be included separately therefrom. Additives which are known to add properties to treated cellulosic materials are suitable, such as, flame retardants, dispersants and/or dyes. For example, the additives may be organic compounds, metallic compounds, or organometallic compounds. In one instance, the additive is a material which improves the wetting or penetration of the polymer into the wood, for example, solvents that are stable in the dispersion. Examples of additives include, solvents, fillers, thickeners, emulsifiers, dispersing agents, buffers, pigments, penetrants, antistatic agents, odor substances, corrosion inhibitors, preservatives, siliconizing agents, rheology modifiers, anti-settling agents, anti-oxidants, optical brighteners, coalescence agents, biocides and anti-foaming agents. Such fillers may include silica, Ca(OH)₂ or CaCO₃. In addition, the treating agent may be used in conjunction with wood preservatives containing, for example, cupric-ammonia, cupric-amine, cupric-ammonia-amine complexes, quaternary ammonium compounds, or other systems. For example, the treating agent may be used with Alkaline Copper-Quaternary ammonium (ACQ) preservative systems. The treating agent may also be used with wood preservative technologies which use zinc salts or boron containing compounds. Optionally, other additives such as insecticides, termiticides, and fungicides may be added to the treating agent. In one instance, the additive is included as part of the dispersion and forms a stable suspension therewith. In one instance, the cellulosic material is prepared as a treated cellulosic material by pressure treatment. The pressure used to pressure treat the cellulosic material may be either higher or lower than atmospheric pressure. In one instance, the pressure is lower than ambient pressure, for example, 0.0001 to 0.09 MPa (0.75 to 675 mmHg). In another instance, the pressure is greater than ambient pressure, for example, 0.1 to 1.7 MPa (750 to 12750 mmHg). It is envisioned that pressure treatment processes known in the art are suitable for impregnating the cellulosic material with the treating agent. The temperature for the pressure treatment may be performed at a range of temperatures, for example, from ambient to 150° C.

In one instance, the treated cellulosic material is prepared according to a treatment protocol. In one instance, the treatment protocol comprises impregnating the cellulosic material with the aqueous dispersion comprising the polybutene and the stabilizing agent.

The treatment protocol comprises one or more of the following steps: (a) depositing the cellulosic material in a vessel; (b) holding the vessel at vacuum for 5 to 60 minutes; (c) introducing the aqueous dispersion comprising the polybutene and the stabilizing agent to the vessel; (d) pressurizing the vessel to 1.03 MPa for 5 to 60 minutes; (e) draining the excess aqueous dispersion; (f) optionally removing excess aqueous dispersion by vacuum and (g) air drying the cellulosic material at 20 to 60° C. for 24 to 48 hours.

The several drying steps may be performed at a range of temperatures, whereby the duration of the air drying step is proportional to the temperature. Suitable air-drying temperatures are between room temperature (roughly 20° C.) and 180° C. The drying may be performed in air, in nitrogen, or other suitable atmosphere.

In one instance, the product of the treatment protocol is surface coated with a water repellant coating. An example of a suitable surface coating is polyurethane.

A water immersion test is used to determine the water repellency of the treated cellulosic material according to the American Wood Protection Association Standard E4-11 procedure (Standard Method of Testing Water Repellency of Pressure Treated Wood). The water immersion test involves first, providing both a treated wafer, comprising a treated cellulosic material prepared as described herein, and a control wafer, comprising a cellulosic material treated according to the first treatment protocol described herein except that the dispersion is replaced by distilled water; second, measuring the tangential dimension of both the treated wafer and the control wafer to provide an initial tangential dimension (T₁) (where the tangential dimension is perpendicular to the direction of the grain of the cellulosic material); third, placing both the treated wafer and the control wafer in a conditioning chamber maintained at 65±3% relative humidity and 21±3° C. until a constant weight is achieved; fourth, immersing both the treated wafer and the control wafer in distilled water at 24±3° C. for 30 minutes; and fourth, measuring the tangential dimension of both the treated wafer and the control wafer following removal from the water to provide a post tangential dimension (T₂).

DoN refers to the degree of neutralization of the carboxylic acid functionality in the polymer.

The percent swelling (S) for each individual wafer (both the treated wafer and the control wafer) is calculated as:

$$S ( \% ) = \frac{{T}_{2} - {T}_{1}}{{T}_{1}} \times 100$$

In each of the Examples herein, the percent swelling of the control wafer is 4.7% for initial test, and 6.75% after wood wafers was leached following the leaching test procedure in experimental session.

Water-repellency efficiency (WRE) is used to determine the effectiveness of the treating agent in adding water repellant properties to the treated cellulosic material. WRE is calculated as:

$$WRE ( \% ) = \frac{{S}_{1} - {S}_{2}}{{S}_{1}} \times 100$$

S₁ refers to the percent swelling of the untreated wafer; S₂ refers to the percent swelling of the treated wafer. According to E4-11, for most outdoor applications a minimum WRE of 75% is preferred.

The following Examples illustrate certain aspects of the present disclosure, but the scope of the present disclosure is not limited to the following Examples.

### EXAMPLE 1

### Dispersion of Polybutene 24 using Tergitol™ 15-S-12

200 g of Polybutene 24 obtained from Soltex Inc. (weight average molecular weight 950, as determined by gel permeation chromatography (GPC)) and 10 g of Tergitol 15-S-12 from The Dow Chemical Company are weighed into a polyethylene beaker. The content of the beaker is stirred at room temperature using a cowles blade at RPM of ˜2000 for 1-2 minutes to obtain uniform mixing. To this mixture water is added approximately at the rate of 3 ml/minute for 10 minutes while maintaining the stirring. Another 170 ml of water is added at a rate of ˜20 ml/minute to obtain the dispersion.

The dispersion particle size measured using a Coulter LS 320 is 1.09 micrometers, and the dispersion solid percentage is 56.8%. The synthesized dispersion is diluted using water to 30% concentration which was used for the wood treatment.

### EXAMPLE 2

### Polybutene 24 with Empicol ESB70

100 g of Polybutene 24 obtained from Soltex Inc. and 7 g of Empicol ESB70 (a sodium laureth sulfate+2E0) manufactured by Huntsman are weighed into a polyethylene beaker. The contents of the beaker are stirred at room temperature using a cowles blade at an rpm of ∫1800 for 1-2 minutes to obtain uniform mixing. To this mixture water is added approximately at the rate of 3 ml/minute for 6 minutes while maintaining the stirring. Another 42 ml of water is added at rate of ˜10 ml/minute to obtain the final dispersion.

The dispersion particle size measured using a Coulter LS 320 is 700 nm and the dispersion solid percentage is 57%. The synthesized dispersion was diluted using water to 30% concentration, which is used for the wood treatment.

Treatment Procedures

The dispersions prepared in Examples 1 and 2 are each used to pressure-treat southern yellow pine wafers. The wood pieces (4 cm*2 cm* 0.5 cm) are each pressed down by a ring in an evacuated Parr reactor for half an hour followed by drawing in 80 ml of the respective dispersion. The reactor is pressurized to 150 psi under nitrogen and maintained for 60 min. Each wood piece is then placed in an oven with air drying at 60° C. for 48 h.

A leaching test is performed by washing each treated wood block with deionized water at 60° C. for 8 hours. The leached wood wafers are dried in an oven in air at 60° C. overnight. The dimensional stability of the dried wood is then conducted following the AWPAS E4-11 procedure, with results listed in Table 1.

| | | Percentage | WRE, | Percentage of | WRE, |
|---|---|---|---|---|---|
| | Aqueous | of swelling | Initial | swelling (after | after |
| Example | Dispersion | (Initial) | leaching | leaching) | leaching |
| Control | none | 4.69% | 0% | 6.75% | 0% |
| 1 | Polybutene 24 | 1.6% | 66.47% | 2.4% | 64.04% |
| | using Tergitol | | | | |
| | 15-S-12 | | | | |
| 2 | Polybutene 24 | 1.7% | 63.14% | 2.2% | 67.40% |
| | with Empicol | | | | |
| | ESB70 | | | | |

As the table above shows, and without being limited by theory, the use of an aqueous dispersion comprising a polybutene and a stabilizing agent forms a protective layer around the pores of the wood, which minimizes the absorption of water by the wood thus providing a significantly longer period of dimensional stability compared to wood which has not been treated with an aqueous dispersion comprising a polybutene and a stabilizing agent. Furthermore, the treating agent is not leached significantly by water.

1. A method for preparing a treated cellulosic material comprising:
(a) providing a cellulosic material;
(b) a treatment protocol comprising impregnating the cellulosic material with an aqueous dispersion comprising a polybutene and a stabilizing agent.

2. The method of claim 1, wherein the polybutene has a molecular weight of less than 3000.

3. The method of claim 1, wherein the stabilizing agent is a non-ionic or an anionic surfactant or a mixture of both.

4. The method of claim 1, wherein the impregnating step of the treatment protocol is conducted under pressure greater than or lower than ambient.

5. The method of claim 1, further comprising impregnating the cellulosic material with an additive.

6. The method of claim 1, wherein the aqueous dispersion contains from 5 to 75 weight percent solids.

7. The method of claim 1, further comprising drying the treated cellulosic material.

8. The method of claim 1, wherein the average particle size of the solids in the aqueous dispersion is less than 50 microns.
